(19) United States
(12) Patent Application Publication
(10) Pub. No.: US 2012/0207386 A1
(43) Pub. Date: Aug. 16, 2012

(54) Updating A Low Frame Rate Image Using A High Frame Rate Image Stream

(75) Inventors: Eyal Ofek, Redmond, WA (US); Ido Omer, Redmond, WA (US); Billy Chen, Santa Clara, CA (US)

(73) Assignee: Microsoft Corporation, Remond, WA (US)

(21) Appl. No.: 13/025,164

(22) Filed: Feb. 11, 2011

(51) Int. Cl. G06K 9/00; G09G 5/00; G06K 9/32

(52) U.S. Cl. 382/168; 382/294; 345/629

(57) ABSTRACT

Technology is described for enhancing low frame rate media or static images using higher-frame rate information. An example method can update a static image using a video stream. The method can obtain the video stream from a video source, and the video stream can be aligned to the static image. Another operation can be analyzing a change in the video stream as compared to the static image. The change can be applied to the video stream to the static image. A further operation may be displaying the static image with the change applied.

### BACKGROUND

To truly experience being at a physical location, a person can be physically present at that location. However, as technologies progress in media capture, image display, wireless data delivery, and mobile computing, the substitute digital experience can become a more compelling substitute.

Some uses for delivering high-resolution, high-frame rate media can be in exploration and planning applications. Sometimes a user may wish to explore a location because the user is planning to visit the location or because the location is unfamiliar to the user. The plans can be as simple as scheduling an evening's events. Where should I eat? Should I visit a nearby location after dinner? What would a night-time walk be like? Such questions can be answered by virtually visiting a location.

The virtual access domain may include: technologies that deliver high-fidelity media at a single point in time and technologies that deliver real-time high frame rate media in low fidelity. High-fidelity media can include relatively high resolution photographs and panoramas. Hi-fidelity media can also cover larger areas of a scene. For example, a satellite image may cover the full shore line of California, while a local camera may show an image of the waves along 100 yards of a beach. Such high-fidelity media can allow a user to capture high-resolution imagery, usually during a short period of time or an instant. By stitching multiple photographs into a single panorama, this enables the creation of panoramic high-resolution imagery. Such high-fidelity media can be effective for capturing events that occur over a short period of time or where a static image is desired.

Other capture technologies can acquire media at a relatively low fidelity but with higher frequency. Video is an example of a media that captures images at a lower fidelity but a relatively high frame rate. Usually, such low fidelity media is captured at 24+ frames per second, enabling the rich capture of events at low fidelity. Because of the high frame-rate, a lot of data can be captured but the capture resolution is usually quite low and the field of view can often be quite narrow.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. While certain disadvantages of prior technologies are noted above, the claimed subject matter is not to be limited to implementations that solve any or all of the noted disadvantages of the prior technologies.

Various embodiments are described for enhancing low frame rate media or static images using higher-frame rate information. An example method can update a static image using a video stream. The method can obtain the video stream from a video source, and the video stream can be aligned to the static image. Another operation can be analyzing a change in the video stream as compared to the static image. The change can be applied to the video stream to the static image. A further operation may be displaying the static image with the change applied. In one example, the combined static image and video stream can be rendered together as an output video.

An example system can update a static image using a video stream. A video input module can receive a video stream from a video source. A static image module can be used to obtain a static image. An alignment module can align the video images from the video stream with the static image based on a reference point between the static image and the video stream. An analysis module can analyze a change in the video stream and apply the change in the video stream to the static image. A rendering module can then render the combined static image and video stream as a high-resolution, high frame rate video.

Another example method can update a low frame rate image using a high frame rate image stream. The method can include obtaining the high frame rate image stream from a streaming source, and aligning the high frame rate image stream to the low frame rate image. An image modification can be analyzed in the high frame rate image stream. The image modification may be an illumination change, movement, or another change. The image modification can be applied from the high frame rate image stream to the low frame rate image. The combined low frame rate image and high frame rate image stream can be rendered as a composite high frame rate image.

### BRIEF DESCRIPTION OF THE DRAWINGS

FIG. 1 is a flowchart illustrating an example of a method for updating a static image using a video stream.

FIG. 2 is a block diagram illustrating an example of a system for updating a static image using a video stream.

FIG. 3 illustrates an example of a 360 degree panorama captured of an office and a higher-frame rate video feed of a subset of the image during daytime.

FIG. 4 illustrates an example of a 360 degree panorama captured of an office and a higher-frame rate video feed of a subset of the image during night.

FIG. 5 is flowchart illustrating an example of a method for updating a low frame rate image using a high frame rate image stream.

### DETAILED DESCRIPTION

Reference will now be made to the exemplary embodiments illustrated in the drawings, and specific language will be used herein to describe the same. It will nevertheless be understood that no limitation of the scope of the technology is thereby intended. Alterations and further modifications of the features illustrated herein, and additional applications of the embodiments as illustrated herein, which would occur to one skilled in the relevant art and having possession of this disclosure, are to be considered within the scope of the description.

A technology can be provided to enhance low frame rate media and/or static images using high-frame rate information. The high-frame rate information may be obtained as an image stream is captured or streamed across a network or the internet. Combining high resolution static images from a first source and high frame-rate information from a second source can allow users to digitally experience a remote location in real-time with high resolution and a high frame-rate. Delivering real-time, high-resolution, high-frame rate media to a user enables a user to: have the experience of “being there”, use exploration applications, and use planning applications.

The term high resolution image can be a higher resolution image as compared to lower resolution motion images delivered across a network or from a computer readable storage medium. For example, a high resolution image can include a multi-megapixel sized image on up to a gigapixel image or greater. Low resolution images can be those motion images that can be transported reliably across a network such as the internet. An example of low resolution images can be sub-megapixel images, such as video frames contained in a video stream.

The term high frame rate can be defined as an image that is updated at a rate of greater one frame per hour or one frame per day. In one example, a high frame rate image or stream can include a rate of 24 frames or more per second (fps) which provides fluid motion to a viewer. In contrast, the term low frame rate can be defined as an image that is updated at a rate lower than one frame per hour or one frame per day. In one example, a low frame rate can be a static image that is updated once each hour or once per day. Another example can be street-side images in a virtual exploration area of an online electronic mapping tool that may be updated once every few years.

The term static image can mean an image that shows little change over a defined period of time. A further example of a static image may include an image that does not have animation movement or illumination changes. For instance, a static image may be updated once an hour but the static image can be static for certain periods of time or replaced by another static image periodically. The term real-time can be defined as captured images that are immediately transmitted across a network, the internet, or another transmission and are displayed to a user as the images are received.

This technology combines aspects of both high frame rate technology and lower frame rate technology to enable the display of high-resolution, high frame-rate, real-time media. Photographs and panoramas can be used as the high-resolution context, and the high resolution images can be enhanced using low resolution, real-time, high-frame rate video. The panoramas can be partial panoramas or full 360-degree panoramas. Often the higher resolution source may have a wider coverage area than the lower frame rate images, and two image sources may have just partial common coverage. The output viewable by an end user can be a high-resolution panorama that responds in the events occurring in real-time in the high-frame rate images or video.

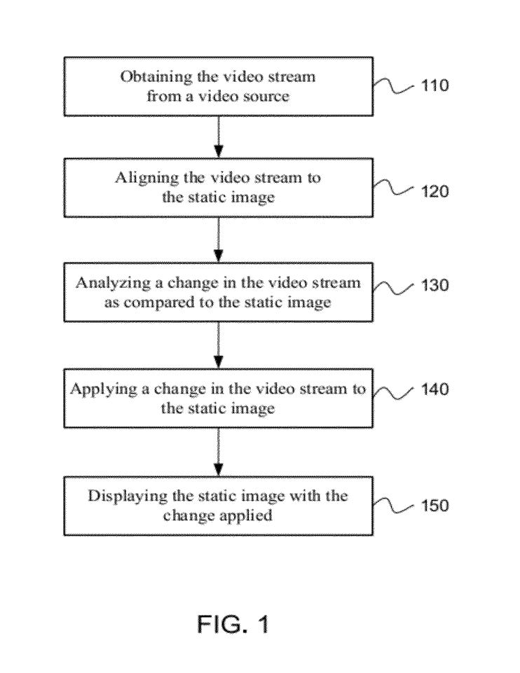

FIG. 1 illustrates an example method for updating a static image using a video stream. The method can include obtaining the video stream from a video source, as in block 110. The video stream can be a high frame rate video stream. The video stream may be obtained from a video camera that is capturing images at a remote location, and the video images may be streamed across the internet, a wide area network (WAN), a local area network (LAN), or another network. The static image can be a high resolution panoramic image or a high resolution rectangular image.

The video stream may then be aligned to the static image, as in block 120. The video stream can be aligned to a reference point of the static image. For example, a user may define an alignment point in the static image and a corresponding reference point or reference object in the image frames of the video. Alternatively, the alignment of a video stream to the static image can use reference points or reference objects that are found using automated methods that can include feature extraction, matching methods, or sensor alignment. The reference points or reference objects may be in the images themselves or the reference points can include mechanical measurements for the photographic equipment being used.

A further operation can be analyzing a change in the video stream as compared to the static image, as in block 130. In an example, an illumination change can be identified in the video stream as compared to the static image. The video stream may show that night has arrived at the location being captured and illumination can be different from the illumination in the static image that was captured during the day.

The change detected in the video stream can be applied to the static image, as in block 140. In the example of an illumination change, changes in the illumination can be applied to the static image based on the illumination that was identified in the analysis phase. The illumination change can use histogram matching to apply the illumination change from the video stream to the static image. If the illumination change is night at the location being captured by the video stream, then nighttime characteristics can be applied to the static image.

In another example, a motion change in the video stream can be identified as compared to the static image. The motion change can then be applied to the static image. The motion change may be applied using sub-region deformations applied to the image. Another method of applying a motion change can be 3-Dimensional (3D) computer graphics modeling, 2-Dimensional (2D) animation, or other techniques for computer modeling of motion. The detected motion change can be stochastic motion or structured motion. In a specific instance, a traffic video camera feed may be used to ‘animate’ cars on roads in an aerial image. A video of wave motion on one beach may be used to animate the waves along a view of the entire California shore line. A video of a moving tree in the wind or a field of wheat may be used to animate a whole rural area. A web cam showing people walking on a pavement may be used to populate a downtown city area with moving people (e.g., the density of the people may be guided by the existence of people in the static image or large area still image).

The static image can then be displayed with the change applied, as in block 150. The static image can be displayed alone or in proximity with the video images. In addition, the video frames may be embedded in a desirable location of the static image for the output video. In one example, the combined static image and video stream can be rendered together as an output video. The output video can be a high frame rate video with a resolution at least as high as the static image. Alternatively, the combined output may be a modified static image that is updated periodically based on a user defined time period. For example, a user may desire that an image panorama or rectangular static image can be updated by the changes in the video every 15 minutes, 30 minutes or hour.

Using the described technology to simulate the experience of actually “being there” has several compelling application domains. One of these application domains is tourism. Oftentimes, a tourist may wish to see a location before actually going there. For example, a tourist desiring to visit Florida's beaches may desire to view, in advance, which beach the user will prefer to visit. It can be equally useful to see if certain bungalows have a view of the beach or if they're blocked by trees or other houses.

Simulating the experience of “being there” is also useful in the real estate domain. Before investing in a house, a purchaser is prudent to go to the location and experience the property. However, a purchaser cannot visit every house available for purchase and having a digital representation for “being there” can save time and help in planning actual visits. This is one reason why real estate websites have accompanying photos and panoramas.

This technology can also show captured media in the media's original context. For example, a picture taken by an end user on a street at night can be displayed and/or embedded in mapping software (e.g., Bing Maps streets) in the right geographic location with previously captured street images that are rendered with the same night conditions.

A further application of this technology can attract people to the media. In one case, a video of a night club's entrance can be shown live on a street in an internet enabled mapping application (e.g., Bing Maps). The streets closer to the point where the current video is embedded can be shaded to match the live video's illumination, as a user navigates closer to the embedded location of the video. Alternatively, streets closer to an embedded video can be progressively shaded with a color, such red or yellow, so a user is more likely to notice the point where the video is embedded.

Another example use of the technology can be bringing a satellite image of an entire state or region (e.g., California) to life by animating: the sea waves, the motion of the trees, and the movements of cars and pedestrians (using current web cam samples in sporadic points in the state.

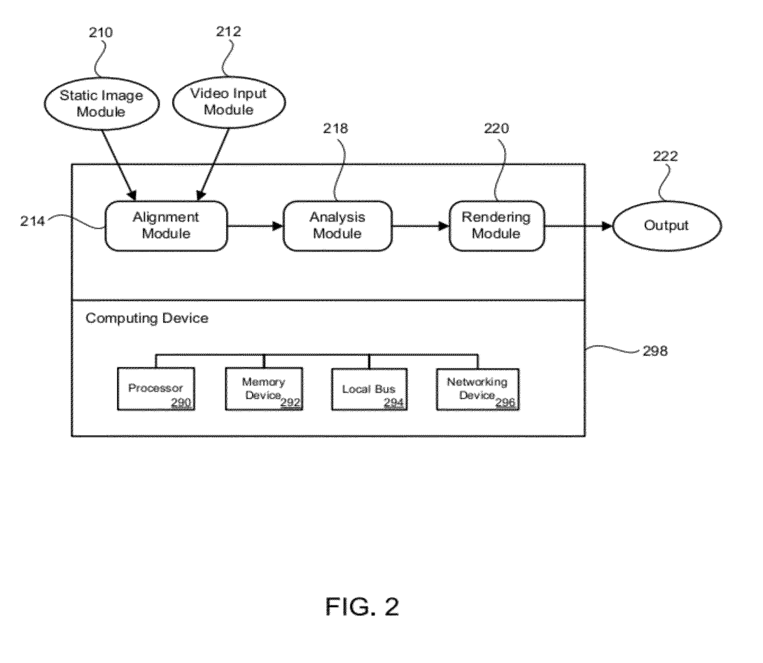

FIG. 2 illustrates a system for updating a static image using a video stream. A video input module 212 can receive a video stream from a video source (e.g., a video camera), and static image module 210 can obtain a static image. The static image can be a high resolution image or a high resolution panorama.

An alignment module 214 can be used to align video images from the video stream with the static image based on a reference point between the static image and the video stream. In one example, the video stream can be aligned to the static image using a reference point in the static image. The reference point(s) in the static image and the videos be manually identified or the reference point(s) can be identified using automated methods that may include feature extraction, matching methods, or sensor alignment. The alignment between the static image and video images can take place using image translation, image rotation, image warping, or image deformation. Masking of the static image can also be used to create an in-set location for the video images to be inserted in the static image. The alignment may also occur dynamically. In other words, videos from rotating cameras, cameras on cars, a TV report of a race, etc. can be merged into the static image dynamically on an ongoing basis as a frame from a video camera frequently moves with reference to the static image.

An analysis module 218 can analyze a change in the video stream and apply the change from the video stream to the static image. In one example, the analysis module identifies an illumination change in the video stream as compared to the static image and applies the illumination change to the static image. The illumination change can be applied using histogram transfer to apply the illumination change from the video stream to the static image. Histogram transfer is a technique that can be based on histogram equalization. Illumination changes may also be applied using a kernel filter to lighten, darken or color an image. In another example, the analysis module can identify a motion change in the video stream as compared to the static image and apply the motion change to the static image. The motion change can be applied to the static image using sub-region deformations or other motion modeling techniques.

The static image and video stream may be combined as a high-resolution, high frame rate video 222 using the rendering module 220. As a result, a single video stream may be output which can be viewed by an end user. As changes occur in the video stream, these changes can be analyzed and then applied to the static image. Alternatively, the modified static image can be displayed alone or alongside the video stream images.

The modules described for FIG. 2 above may execute on computing device 298 that is a server, a workstation, personal computer, or another computing node. The computing device or computing node can include a hardware processor device 290, a hardware memory device 292, a local communication bus 294 to enable communication between hardware devices and components, and a networking device 296 for communication across a network with other image generation modules, processes on other compute nodes, or other computing devices.

Additional detailed examples of this technology will now be described for updating high-resolution images from a captured location to match the real-time illumination, events, and motions present at the captured location by exploiting video from the same location. The system may align, analyze, and render an input image and video together as a single high-resolution, high-frame rate, real-time video (or as an updated image alone).

The technology can enhance static photos and panoramas in a several ways. The low frame-rate images can be enhanced by adjusting the apparent illumination and by animating motion that would otherwise be unchanged or change very little in the static image. The video from the captured location can also contribute or modify the sounds being presented with the final rendered video.

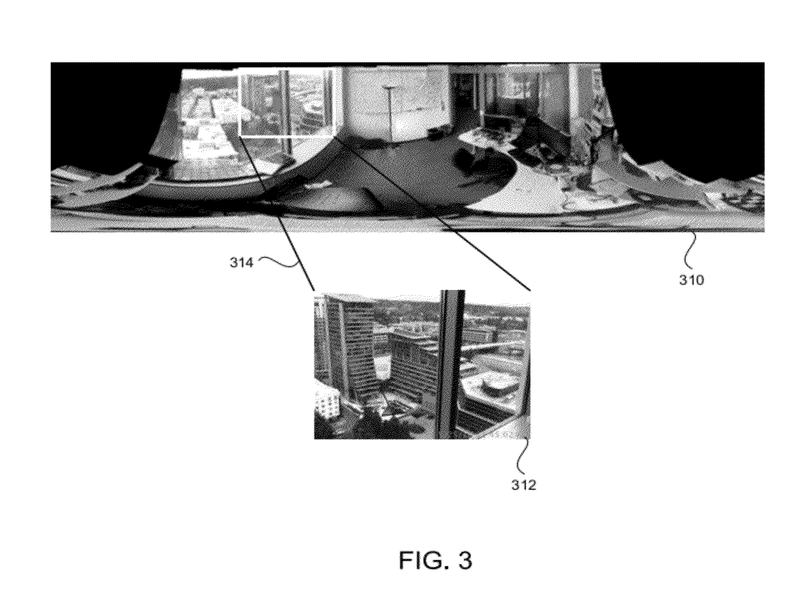

The input to the technology can be an image and a video. The image may be a single photograph or a composition of photographs, as in a stitched panorama. The photograph or panorama can be considered a low frame rate image. For example, the image may be a 360-degree panorama captured of an office 310, as shown in FIG. 3. The video may be a higher-frame rate video feed 312 of some subset of the image. For instance, the video may be a webcam feed that is configured to stream live, high-frame rate video of a specific sub-view of the office and hence the panorama. The video may be obtained from a video stream that is obtained from a video stream being sent over the internet. As can be seen, there may be a correspondence 314 between the video frame and the video frame's position in the panorama.

The image and video can be input to an alignment block (as in FIG. 2). The alignment block can align the pixels of the image to a frame of the video. This alignment may assume the video is fixed in position with respect to the image; otherwise the alignment may produce a frame-dependent output. The alignment can either be performed automatically, semi-automatically, or manually. Automatic alignment means feature extraction and matching techniques can be used, including Structure-from-Motion or tracking methods often used with computer vision systems. Alignment can also be performed using cameras aligned by sensors which sense location, orientation, and camera positioning. Such sensors are becoming more common in many cameras, mobile devices, and phones with cameras. Examples of such sensors may be global positioning system (GPS) sensors, compasses, or orientation sensors. As discussed previously, the alignment of the video frame to the static image may also be dynamic, where video frames from moving camera may be dynamically incorporated into the final image. For instance, a video frame with a changing location with reference to the static image can be integrated into the static image each time the video camera moves.

In an example of manual alignment, a manual technique can be used for specifying point correspondences between the video and image. The technology may assume a planar proxy between the video and image. However, the planar limitation can be dropped and other correspondence surface types may be used (e.g., curved surfaces). The output of the alignment block may include a binary mask in the image space, specifying where the video pixels may be located with respect to the image. A warping function may be specified, so that video pixels may exactly correspond to image pixels. While the warping function and binary mask may be redundant because the mask can be derived from the warping function, including a binary mask can be convenient when a statistical correspondence is used (e.g., computing histograms) over a pixel-wise correspondence between two images.

In an analysis block (as in FIG. 2), the video and image correspondence can be used to enhance the image to look more like the video. As mentioned before, this may include certain enhancements to illumination and motion. In an illumination enhancement, the output image's illumination can be enhanced to look like the input video. If the video contains illumination changes then the output video can also exhibit the same illumination changes. For example, if the input image was a panorama captured during the day and the live video stream was at night, the output image or video can be modified to look like a panorama captured at night.

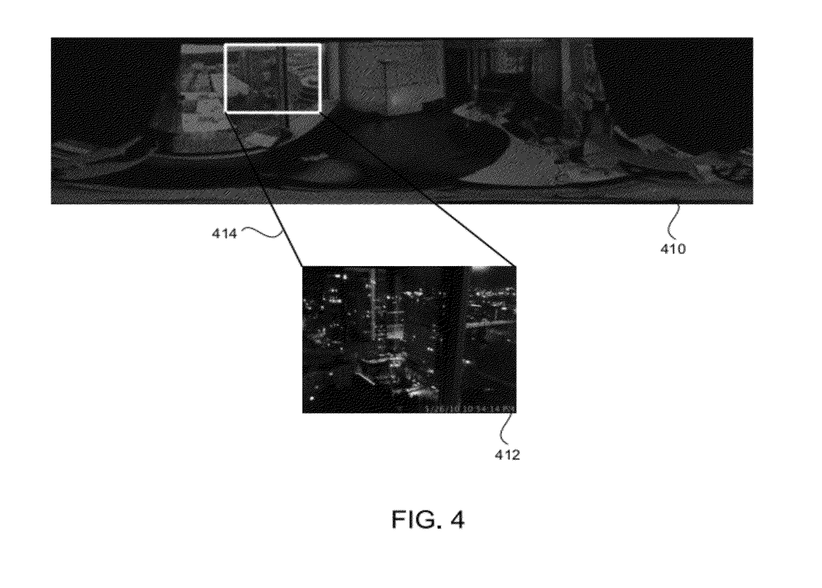

FIG. 4 illustrates a further example of illumination enhancement. An image of webcam video 412 at night is illustrated. In addition, the enhanced panorama has been modified to simulate night lighting using the night time video 410 as an illumination reference. To accomplish illumination enhancement, histogram matching may be performed between the video and the image pixels that lie within the mask. The same histogram transfer function can be applied to the remaining pixels of the image.

Other enhancements can include motion extrapolation. In this case, the motion of events occurring in the video can be extrapolated as sub-region deformations in the image. The motions themselves can be further categorized into stochastic and structured motion. Stochastic motion can include motion that may be characterized by sampling from a random process, such as Gaussian or exponential. Such processes can be used to model seemingly local random motion, such as ocean waves or the gentle weave and bob of trees in the wind. Other examples include modeling cloud motion in the sky. In a video, motions can be detected via tracking and segmented into local motions. If known, motion models and models of prior motions can also be used, such as the vertical, periodic motion of waves. Structured motions can be the extrapolation of motions such as automobile traffic, machine movement, repetitive crowd movement, or other similar motions.

Once motions have been extracted and segmented, corresponding image textures may also be matched from the video to the image and applied to provide motion in areas of the higher resolution image that are similar to the areas of the video with motion. In contrast to illumination enhancement, the alignment correspondence for motion can be augmented with a matching between clouds, water, and trees in the video with those movements found in the image. Other examples of motion and/or varying illumination can be providing twinkling city lights, static stars in the sky, or stars twinkling in the sky. Existing matching methods, such as Scale-Invariant feature transform (SIFT) matching, and Maximally Stable Extremal Regions (MSER) can be used to find approximate matches for clouds, water, and tree areas with identified movement.

In the past, images have used animation to provide motion with procedural animation or other modeled motion, such as clouds to synthetically interpolate for the whole sky. However, the present technology uses an image or video as a guide to add motion to area areas that do not have motion. In other words, the high frame rate video can be used to enhance the imagery of the low frame rate photo. Video can be captured by a spatially sparse sensor and the areas that are common between the video and the photo can be used to infer the appearance and motion in other photo areas outside the video areas.

The final processing module can be a rendering block (as in FIG. 2). This block can execute a desired blending to finally composite the video into the image and provide a single video output stream. Blending techniques such as Laplacian or Poisson blending can be used for blending the images or image edges. Alternatively, the modified static image can be displayed alone or alongside the video stream images.

The final output may be a video with the high-resolution of the original captured image but also including the changes of the high-frame rate, real-time video. Thus, the system can enhance photos and/or panoramas several ways including: by adjusting the apparent illumination and by animating motion that would otherwise not move substantially in the static image.

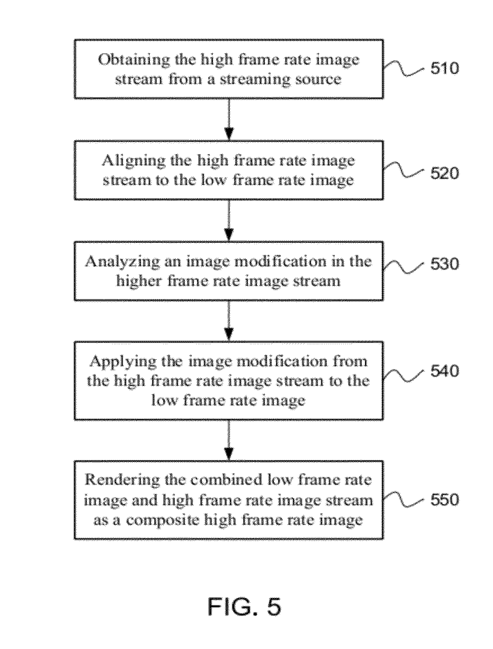

FIG. 5 illustrates a further example method of the technology for updating a low frame rate image using a high frame rate image stream. The low frame rate image can be a full or partial panorama or another static photographic image. The method can include the operation of obtaining the high frame rate image stream from a streaming source, as in block 510. The streaming source may be a video file on a hard drive, a video file on an optical disk, a recorded video stream sent over a network, or a live video stream over the internet. The high frame rate image stream can be aligned to the low frame rate image, as in block 520.

An image modification in the higher frame rate image stream can be analyzed as in block 530. The image modification can be an illumination change, a motion change, or another change. The image modification can be applied from the high frame rate image stream to the low frame rate image, as in block 540. The combined low frame rate image and high frame rate image stream may be rendered as a composite high resolution, high frame rate image, as in block 550. Alternatively, the modified static image can be displayed alone or alongside the video stream images.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables for an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more embodiments. In the preceding description, numerous specific details were provided, such as examples of various configurations to provide a thorough understanding of embodiments of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method for updating a static image using a video stream, comprising:
obtaining the video stream from a video source;
aligning the video stream to the static image;
analyzing a change in the video stream as compared to the static image;
applying a change in the video stream to the static image; and
displaying the static image with the change applied.

2. A method as in claim 1, wherein displaying the static image further comprises rendering the combined static image and video stream as an output video.

3. The method as in claim 1, wherein applying a change further comprises:
identifying an illumination change in the video stream as compared to the static image; and
applying the illumination change to the static image.

4. The method as in claim 3, wherein the illumination change uses histogram matching to apply the illumination change from the video stream to the static image.

5. The method as in claim 1, wherein applying a change further comprises:
identifying a motion change in the video stream as compared to the static image; and
applying the motion change to the static image.

6. The method as in claim 5, wherein the motion change uses sub-region deformations to apply the change to the image.

7. The method as in claim 5, wherein the motion change is stochastic motion or structured motion.

8. The method as in claim 2, wherein the output video is a high frame rate video with resolution at least as high as the static image.

9. The method as in claim 1, wherein the static image is a high resolution panoramic image.

10. The method as in claim 1, wherein the video stream is a high frame rate video stream.

11. The method as in claim 1, wherein aligning the video stream to the static image further comprises aligning the video stream to a reference point of the static image.

12. The method as in claim 1, wherein aligning the video stream to the static image further comprises aligning the video stream to a reference point of the static image using feature extraction, a matching method, or sensor alignment.

13. A system for updating a static image using a video stream, comprising:
a video input module to receive a video stream from a video source;
a static image module to obtain a static image;
an alignment module to align video images from the video stream with the static image based on a reference point between the static image and the video stream;
an analysis module to analyze a change in the video stream and to apply a change in the video stream to the static image; and
a rendering module to render the combined static image and video stream as a high-resolution, high frame rate video.

14. The system as in claim 13, wherein the analysis module identifies an illumination change in the video stream as compared to the static image and applies the illumination change to the static image.

15. The system as in claim 14, wherein the illumination change uses histogram matching to apply the illumination change from the video stream to the static image.

16. The system as in claim 13, wherein the analysis module identifies a motion change in the video stream as compared to the static image and applies the motion change to the static image.

17. The method as in claim 13, wherein the motion change uses sub-region deformations to apply the change to the static image.

18. The method as in claim 13, wherein aligning the video stream to the static image further comprises aligning the video stream to a reference point of the static image.

19. A method for updating a low frame rate image using a higher frame rate image stream, comprising:
obtaining the high frame rate image stream from a streaming source;
aligning the high frame rate image stream to the low frame rate image;
analyzing an image modification in the higher frame rate image stream;
applying the image modification from the high frame rate image stream to the low frame rate image; and
rendering the combined low frame rate image and high frame rate image stream as a composite output.

20. The method as in claim 19, wherein the image modification is an illumination change or a motion change.
